(19) United States
(12) Patent Application Publication
(10) Pub. No.: US 2022/0392045 A1
(43) Pub. Date: Dec. 8, 2022

(54) TOPOGRAPHICAL BALLISTIC IDENTIFICATION WITH SECTION PROFILES AND COMPARISON SYSTEM

(71) Applicant: Vural DERYA, Nilüfer, Bursa (TR)

(72) Inventor: Vural DERYA, Nilüfer, Bursa (TR)

(21) Appl. No.: 17/776,456

(22) PCT Filed: Nov. 13, 2020
(86) PCT No.: PCT/TR2020/051099

§ 371 Date: May 12, 2022

(30) Foreign Application Priority Data
Nov. 15, 2019 (TR) 2019/17866

(51) Int. Cl. G06T 7/00; G06T 7/40; G06V 10/74

(52) U.S. Cl. CPC G06T 7/0002; G06T 7/40; G06V 10/761; G06T 2207/30136; G06T 2200/04

(57) ABSTRACT

A topographical identification and comparison system which converts other examples of the same kind or with parts of the examples of topographical structures having fixed references such as circular, rectangular and square, regular polygon to a digital data such as trace and wavy structural conditions of the surface areas and which carries out similarity comparison of this data by soft mathematical calculations.

### TECHNICAL FIELD

The invention relates to identification and comparison system by converting to a digital data which will be capable of carrying out the similarity comparisons of topographical structures such as the trace and wavy structural conditions of the surface areas having fixed references such as circular, rectangular and square with other examples of the same kind or for example with a portion of it substantially for bullet casings and cartridge bullets.

The invention relates to an identification and comparison system between photographs of things of all scales which are in need of surface structure comparison, together with the characteristic traces which the weapon leave on the cartridge case bottom table and cartridge bullet at a ballistic investigation area; modellings taken with a laser scanning tool; or standard reference digital example of a structure and directly real examples; and which automatically carries out the similarity comparison between other traces of the same kind.

### PRIOR ART

Basic topographical and morphological parameters are needed in the preparation of urban and rural land utilization plans, assessment of agricultural, forestry and disaster risks and in many similar studies. Presently, Geographic Information Systems (GIS) has become a powerful tool for the modelling of the earth, positional and 3-dimensional analyses with the developed software. Numerical Altitude Model (NAM) is the digital visualization of the topography, and it is represented in the grid, TIN (Triangulated Irregular Network) and contour structure. Numerical Altitude Model comprises some error and uncertainties depending on data and model, and these errors affect details derived from Numerical Altitude Model systematically. Developments in the Geographic Information System and remote detection technologies have facilitated obtaining topographical data. Said physiographic properties of a land can be determined with the aid of a numerical land model to be formed. Data required for this model can be obtained as a result of terrestrial measurements, photogrammetric methods or as a result of digitalization of existing maps. In addition to these, by using Geographic Information Systems (GIS) numerical altitude models are being produced and topographical analyses can be carried out. In recent years, remote detection data and methods are being used in land modelling too. Numerical altitude models can be produced with remote detection data which are called SRTM (Shuttle Radar Topography Mission) data. SRTM data consists of numerical altitude data obtained by radar detectors which are placed in a space shuttle.

Surface structure identification and comparison method is being applied in the ballistic field in smaller bullet casings and cartridge bullets too as being done in large areas. When three dimensional images of the traces obtained by certain different methods that are present on cartridge cases and cartridge bullets, they are seen as topographical surface structures similar to the above narrated large surface structures. In general, in the investigation of the traces on the bullet casing, in the existing systems in the first stage, zones which are the distinct areas of the surface structures such as cartridge case bottom table outer circle, weapon firing pin impact trace over the capsule, ejector trace zone which enables empty cartridge case to be thrown outside the weapon after shooting and trace circles or capsule circle which the housing in which the firing pin of the weapon moves in it because of the recoil pressure after the explosion has left on the capsule can be determined by means of software or operator. This determination operation is being done by drawing a circle and marking the ejector trace zone after been taken within a closed line. Following this determination operation, the software superposes the data of two separate 3 dimensional cartridge case to be compared, holds one of them fixed and moves the other one by turning it from its center at each unit degree, separately in the x-y-z axes too step by step to mark each trace. For each one of these movements, a similarity score is being given according to the similarity situation. This similarity study technique is being applied separately for each data that is present in the archives. Consequently, all data present in the archives is being transmitted to the operator with the sequencing from the one which has got most similarity scores to the one which has got the least similarity scores. The expert tries to find the similar data by looking at them with this sequence. The most attention grabbing negativity in the existing application is the fact that data which is the basis for identification and thus comparison operation, that is, determination of the trace zone is being performed by the operator. Although a portion of it can be determined by the system, it has been left to the operator inspection. This situation can be accepted as an indicator of setbacks in performing this determination operation in conformity with the intended rules in the trial stages of the system. The system marks some of these zones itself and afterwards the operator checks whether these markings of the system conform to the rules or not. The operator corrects any nonconformity which he has seen during the inspection and enters the data record to the system in this manner. Only the operator can determine some trace zones (such as ejector trace) that are used in identification. When the cartridge case bottom table surface is being considered, these determinations are being done in fact so small to be measured in millimeters, and in proximal areas with all other data to be entered to the archives. It is exactly here that the negative effect of this situation of the system appears as a result. The system itself scans its entire physical source (bottom table surface structure of the bullet casing and the traces over the cartridge bullet) digitally and cannot convert to a digital data with which it can compare with a similar one or other ones. This can cause sequencing distally on the list which comes in front of the operator despite the information subjected to similarity study having actually a high similarity situation with the information in the system data base. And the distance in between increases according to the number of similar data matching the acceptable deviation range which the operator uses while he is scoring especially the dissimilarity area originating from data entry by a separate operator and similarity of the system. That is to say, as the amount of information loaded to the system increases, increase of system efficiency should be the natural expectation in this situation the ratio of having doing job to the purpose reduces.

In order to explain the comparison operation performed by the existing method via the comparison operation according to the pin impact trace by example; in the data similarity study of an X centered pin impact trace which is located on the cartridge case bottom table circle that has been previously entered to the system belonging to the sister cartridge case with a newly entered Y centered pin impact trace, both of which have been fired with the same weapon, when all system data is subjected to comparison operation one by one with the existing method, all old archive data record which has centers in the zone which is situated between circles A and B that pass through the centers of outer perimeters X and Y with their centers being the center of the cartridge case, with pin impact trace diameter being close to diameters X and Y, will enter between two cartridge case information in the sequencing. That is to say, the positioning of two cartridge cases which are in fact sisters at upper turns of the sequence in front of the operator depends on how similar the previous and the present operator who is doing the entering draw the circles during entry. In this way existing systems use these circle lines in the comparison.

Many studies have been realized in order to eliminate the negativities that are present in the existing technique and to perform more reliable identification operation. One of these studies is the invention which is the subject of patent number EP2583054B1 and titled “Obtaining 3D Topographical Images Belonging to Tool Traces by Using Non-linear Photometric Stereo Method”. A method aimed at directing generally specular quality of metallic surface and especially ballistic evidence parts by using photometric stereo by the identification and solution of more than one non-linear series of equation comprising a distributed period of time and a specular period of time for determining a surface normal vector area N(x, y) and by using N(x, y) for the determination of a 3D topography Z(x, y), and a 3D image acquiring system is being disclosed.

Another study is the invention which is the subject of patent number EP1776557B and titled “3 Dimensional Bullet and Bullet Casing Analysis”. It is a method and an apparatus to obtain a surface map of a ballistic evidence piece (BEP) being studied which can be used as a 3 dimensional signature for the purpose of identification later during ballistic comparison test such as a bullet or a spent bullet casing. The method includes providing a measurement unit that has been adapted to obtain a relief map of BEP's surface and obtaining map of the surface of the BEP by obtaining the relief map of the surface with the measurement unit. The measurement unit of the present invention comprises preferably a confocal sensor such as a confocal microscope. The present invention also comprises obtaining a relief map of the surface of the bullet or surface of bullet casing by obtaining a mosaic of zonary reliefs which partly match with the surrounding zonary reliefs and gathering them.

Another study is the invention which is the subject of patent number WO2013182871 and titled “Shape Criterion Which Can Be Used in the Comparison of Cartridge Bullet and Cartridge Case and Polynomial Coefficients Based Track Analysis and Comparison Method in Criminology Field”. This invention relates to the selection of approach and feature to be used in order to find the MG similarities in the analysis and comparison of traces (MG—traces of a gun) over cartridge bullets, cartridge cases and parts thereof fired from weapon in the field of criminology. In this method, MG analysis is being performed by using the 3-Dimensional surface topographic information and some feature information (2 dimensional photograph features) obtained therefrom.

Another study is the invention which is the subject of patent number EP1505547B1 and titled “Method Directed at Topographical Formation of Land and Road Network and Measurement of Data Related to its Morphology, Processing and Usage”. The invention relates to a method aimed at management of commercial advertisement or traffic signs, collection of data related to the topographical suitability of a road network on a terrestrial area (land) or on a predetermined land for the formation of especially a Road Qualification, at least one measurement aimed at publishing with the operation and computer done by obtaining many digital images of the land from the top of a piece of land. This method essentially intends the step of interpreting the digital images by marking many structural elements on the land and on the corresponding image; then transferring the same images or printouts/samplings to a central information processing server with the option of sending to the peripheral device. Integration of the data in the step of interpretation of digital images with the data measured on the land provides formation of an integrated and central data file in the central processing unit. This integrated data file can be accessed via Internet by the aid of access procedures of the network direction type.

Another study is the invention which is the subject of patent number TR2008/02625 and titled “Trace Analysis Which is Formed as a Result of Metal to Metal Interaction and Which Could Be Used In Criminology Field and Comparison Method”. This invention relates to the selection of approach and feature to be used in order to find the trace which is formed as a result of metal to metal interaction and which could be used in criminology (MMI)—traces over the cartridge bullets, cartridge cases and parts thereof which are shot from weapon; traces which the edged weapons and piercing weapons leave on various metal media; traces which metal tools and materials leave on various metal surfaces; and/or themselves or certain conversion/conversions of all of these traces and/or MMI similarities in the new trace analysis obtained as a result of filter/filters and its comparison. In this method, MMI analysis is being performed by using 3-Dimensional surface topographic information and some feature information obtained therefrom. Methods disclosed in this patent can be used in the comparison of shoe traces, tire traces, three dimensional model of human face and three dimensional traces of any similar two or three dimensional object.

Consequently, due to the need for an identification and comparison system which eliminates the disadvantages that are present in the existing technique and because of the insufficiency of the existing solutions about the subject it has been necessary to perform an improvement in the related technical field.

### BRIEF DESCRIPTION OF THE INVENTION

The present invention relates to identification and comparison system which meets the above mentioned requirements, which eliminates all of the disadvantages and which offers some additional advantages by converting to a digital data which will be capable of carrying out the similarity comparisons of topographical structures such as the trace and wavy structural conditions of the surface areas having fixed references such as circular, rectangular and square with other examples of the same kind or for example with a portion of it substantially for bullet casings and cartridge bullets.

Based on the prior art, the object of invention is to provide the usability in topographical comparison and identification operations for all surface areas including ballistic by means of comparing surface photographs of all scales, models taken with a laser scanning tool or standard reference digital example of the structure which are in need of surface structure comparison of the developed identification and comparison system with directly real examples.

The object of invention is to provide identification of the waves and traces which the weapon leaves on cartridge bullets and cartridge cases in the ballistic identification and comparison system by automatically definition by the software by means of reading the obtained photographs of cartridge case and cartridge bullets, conversion of these photograph files to another digital information which is an assembly of variables whose fixed references are the same which the computer software can calculate the details with each other separately.

The object of invention is to provide identification of identificatory waves and traces by automatically identification in the topographical ballistic identification and comparison system by the software by means of making measurable digital coordinate naming of certain or all pixels with standard tables of the size of pixel number again in the photographs of the section profiles taken in the pixel ratio in the photographs from fixed reference points of the surface images.

The object of invention is to provide direct detection of the entire surface area in the ballistic identification and comparison system by the software by means of making measurable digital coordinate meaning of certain or all pixels together with so called characteristic traces.

Another object of invention is to provide lowering the required processor power and thus reducing the cost by means of similarity study being performed only by numerical calculation since the ballistic identification and comparison system has done measurable digital coordinate naming of certain or all pixels.

Another object of invention is to provide in the ballistic identification and comparison system, elimination of negative effect of operator variable by doing the measurable digital coordinate naming of certain or all pixels, and performing the comparison operation by doing automatically with the magnitude calculation of these values.

Another object of invention is to find similar profile lines in the identification and comparison system and by taking this profile line as the reference to provide determination of archive data having higher probability of similarity by means of comparison of the other profile lines.

Another object of invention is to provide reduction of influence on the result of variable factors which are required to be calculated by means of separately designation of deviation values, determination and the instruction to use different values for these situations being previously defined to the system while doing the comparison similarity in the identification and comparison system.

Structural and characteristic features of the invention and all of its advantages will be understood more clearly by means of the detailed description given below and therefore it should be appreciated by considering this detailed description.

### DETAILED DESCRIPTION OF THE INVENTION

In this detailed description, the identification and comparison system by converting to a digital data which will be capable of carrying out the similarity comparisons of topographical structures such as the trace and wavy structural conditions of the surface areas having fixed references such as circular, rectangular and square with other examples of the same kind or with a portion of it substantially for bullet casings and cartridge bullets of the invention are described aimed at only better understanding of the subject and without forming any limiting effects.

A preferred embodiment of the invention has been used for the purpose of ballistic investigation of said identification and comparison system. Traces which are left on the cartridge bullets and cartridge cases of weapon are wearing formed by the friction of two metals. A surface topography is being observed when looked at zoomed images in macro or micro scale. Although these identificatory waves left by the weapon can be seen in detail on three dimensional or two dimensional photographs, they cannot be defined by the software in the currently used existing applications and systems. In the said identification and comparison system, definition by the software has been provided by means of these photographs being read by a method, being converted to another digital information which is an assembly of variables whose fixed references are the same which the computer software can calculate the details with each other separately.

Said identification and comparison system provides converting to a digital data which will be capable of carrying out the similarity comparisons of topographical structures such as the trace and wavy structural conditions of the surface areas having fixed references such as circular, rectangular and square with other examples of the same kind or for example with a portion of it substantially for bullet casings and cartridge bullets via computer software. Said identification and comparison system provides especially the characteristic traces which the weapon leaves on the cartridge case bottom table and cartridge bullet at a ballistic investigation area to automatically carry out the similarity comparison between other traces of the same kind. Said identification and comparison system provides the comparison of 2 or 3 dimensional photographs of all scales with directly real examples such as with modellings taken with a laser scanning tool or standard reference digital example of the structure and a product passing along the production belt which are in need of surface structure comparison. Said photograph/graphical or laser scanning data is currently being formed by existing systems or techniques.

Topographical section profiles are the name given to a tool which is present in the existing applications in prior art, not used in archives scanning but used for the purpose of visual data in the one to one comparison. The tool is in a state which can be used actively in the one to one comparison. However, it is in a state whose working with a stable measurement data has not been intended and has not been designed. Digital image files consist of pixels. A pixel can only be a single color and it does not have a particular size. It is possible to mention with how many pixels a real measurement can only be expressed digitally (PPI Pixel-Per-Inch). In the said identification and comparison system, basically measurable digital coordinate naming of certain or all pixels of these profiles taken from the fixed reference points of surface image are being taken in the extent of the pixel ratio in the photograph in a great number sections is being done. The reading of the photographs by converting to numerical data provides detection of the entire surface area together with the so-called characteristic traces directly by the software.

While entire surface areas are being studied with the said identification and comparison system primarily measured topographical section profiles are being formed, then coordinated profile tables and section profiles are being defined as measurable variables, after data base archive files are being formed by writing these variables to the surface data base archive file, and then the archived surface data base information are being compared. Said sized topographical section profiles are the scaled section view of two or three dimensional photographs of all scales, modellings taken with a laser scanning tool or standard reference digital example of a surface structure. These images are being converted to numerical values. In a preferred embodiment of the invention, by taking the cartridge case bottom table surface as the central reference, in the 360° circle surface, in the desired level of detail, profile lines can be drawn one each per unit degree, or in a number which can be greater such as 360 each per 1 degree or 360000 each per 0.001 degree. The number of this profile lines varies according to the pixel situation of the photograph. Said coordinated profile tables are tables with each pixel line could be a numerical variable as well as determined with any other measurable name by taking pixel dimensions of the photographs into consideration in vertical and horizontal. Said archive data base files consist of columns and rows. Each unit square of profile lines placed in the said coordinated profile tables or vertical and horizontal coordinate values of its pixels are being written in sequence in the row of the archive data base file. Each row of archive data base file expresses a profile line. When in this manner the entire profile lines are recorded in a data base file, each row becomes the numerical expression that is to say identity of a profile line, and the entire file becomes the numerical expression of a cartridge case or surface topography.

In the said identification and comparison system, in the definition of section profiles as measurable variables, coordinated profile tables are being used. Said coordinated profile tables are being placed in tables of which each pixel line measurements have been determined by taking pixel dimensions of the photograph into consideration in vertical and horizontal. While said coordinated profile tables are being formed, they should be fixed to common references in its entirety. These fixed ones can be done while the photograph is being formed or after the photograph is loaded to the system by various methods by forming references with certain pixel number.

In the said identification and comparison system, while the surface data base archive file is being formed, the fact that vertical and horizontal pixel lines of coordinated profile tables have been defined with a measurable variable provides each pixel to be expressed with a measurable coordinate name. Each unit square of profile lines placed in the said coordinated profile tables or vertical and horizontal coordinate values of its pixels are being written in sequence in the row of the archive data base file. Each row of archive data base file expresses a profile line. When the entire profile lines are recorded in a data base file in this manner, each row becomes the numerical expression that is to say identity of a profile line, and the entire file becomes the numerical expression of a surface or cartridge case topography.

In said identification and comparison system, in the stage of comparison of surface data base information, from now on data base information has left the state of an image data and has been converted to another kind of digital information in which different operation and calculations related to the desired zone can be done. The software can perform comparison in the desired criteria and form by doing only numerical magnitude calculations.

Said identification and comparison system basically consists of four operation stages, namely obtaining topographical section profiles, formation of profile tables and placement of section profile lines in these tables, formation of data base archive file and comparison of data base information. In the said stage of obtaining topographical section profiles; in 360-degree circle surface, in the desired level of details, one each per unit degree (360 each per 1 degree or 360000 each per 0.001 degree) profile lines are being obtained by taking the fixed portion of the demanded surface as the reference. Profile tables and each pixel line in vertical and horizontal with a measurable name (with a number data) are being determined by taking into consideration pixel dimensions of the photograph which will provide definition of the section profiles as measurable variables (numerical data). Profile lines are being placed to the tables in a manner where its portion starting from the center of three dimensional image (from common fixed reference) to be 0 in horizontal. This placement operation can be done by forming a data, that is to say, by forming a table file or by only calculated logically. It is necessary for the tables to be rendered standard for the section profiles of all archive photograph information in vertical and horizontal. This can also be done by forming certain references with the pixel number after the photograph has been loaded to the system by a resetting while photograph is being taken. While data base archive file is being formed, vertical and horizontal coordinate name values of each unit square or pixel of the profile lines which are placed in the profile tables are being written in a sequence the entire profile lines are being recorded in separate rows, and the completed data base file is being associated with the firstly recorded image data. And to which surface data this data base file belongs to is being determined by associating with the recorded photograph file, and is being recorded as such. The process up to here is the main process which will be the basis for the operations to be done afterwards. The fact that each pixel, and thus each surface shape has been converted to a calculable expression provides from now on similarity comparison of data base information with each other to be done in more detail. While data base information are being compared similar profile line or lines are being found primarily; while comparison operation is being performed standard or acceptable deviation values to be used are being entered as +and − number of pixel values on the horizontal and vertical axes of the profile tables. With the crude photograph data loaded to all these operations which form the first stage of the said identification and comparison system, a data base is being brought to be usable by forming it and the first main interrogation operation is being performed.

In the main interrogation operation, comparison is being started after an archive data of the operator is being loaded to the system with another surface or surfaces of whose surface data has been previously recorded. In this stage, primarily similar (reference) profile lines resulting from the calculation made are being sequenced according to similarity ratio and among the ones with the same data reference the one with the highest similarity condition is being determined as the profile line. The comparison starts firstly from the coordinate value of a profile line in the data to be compared, or if there is a predetermined zone of that line for comparison, from the first pixel of that zone. Magnitude calculation is being performed with the coordinate values of each pixel, or if there is a predetermined zone for comparison, with the pixels of that zone, with the coordinate values of the entire archive data or with the profile lines of the archive data or if there is a predetermined zone for comparison with the coordinate values of the pixels of that zone. Later on, similar archive data are determined and archive data which profile lines determined by performing magnitude calculation with the similarly respective surface coordinate values are associated with are being sequenced according to similarity condition by using scoring or a similar method. Archive data which has been sequenced is being calculated separately within the desired similarity ratio range with all profile lines (reference profile line being used as auxiliary) of the comparison data of the remaining all profile lines. In the said identification and comparison system, finally similar archive data or data with the desired sequencing is being transmitted to the operator.

In the identification and comparison system which is mentioned as being different from the existing technique, the portion of the similarity comparison performed prior to the operator is being performed by going into more detail. Since the similarity study will be performed only with numerical magnitude calculation, the required processor power will drop and thus cost of the identification and comparison system becomes less. Finding the similar profile line with the said identification and comparison system has enabled comparison of the other profile lines by taking this profile line as the reference and ultimately determination of archive data having higher similarity probability. For similarity comparison, by selecting certain permissible zones, scanning of the entire archive information only on the basis of those zones is being provided. While performing similarity comparison, material hardness to be determined in order to reduce the effect of some variable factors which must be calculated to the result, it is possible to specify and to determine trade name model properties and similar deviation values separately, and for these different situations definition of use of different values instructions previously to the identification and comparison system is possible. On the other hand, while similarity comparison is being performed, comparison can be performed with the same zone on the other surface of the independently selected zone.

1. Identification and comparison system by converting to a digital data which will be capable of carrying out the similarity comparisons of photographs of topographical structures such as the trace and wavy structural conditions of the surface areas having fixed references such as circular, rectangular, square and regular polygon with other examples of the same kind or with a portion of it characterized by comprising;
formation of coordinated profile tables in which surface section profiles are being defined as measurable variables by converting them to numerical values, pixel numbers are being determined on the vertical and horizontal axes by taking into consideration pixel dimensions of the photograph and each pixel being determined with a measurable coordinate name on vertical and horizontal axes,
formation of surface data base archive file in which number of columns forming in a number determined according to the number of pixels of the profile tables, each row expressing a profile line, all of them being the numerical expression of a surface or cartridge case topography,
data base information leaves the state of being an image data and being converted to a digital information kind in which different operation and calculations related to the desired zone can be performed and similarity study being performed by automatically comparing with the surface data base information formed in this way.

2. Topographical identification and comparison system according to claim 1, wherein while all surface areas are being investigated primarily measured topographical section profiles are being formed.

3. Topographical identification and comparison system according to claim 1, wherein vertical and horizontal pixel lines of the coordinated profile tables are defined with a measurable variable and thus each pixel is expressed with a measurable coordinate name.

4. Topographical identification and comparison system according to claim 1, wherein section profile lines placed in the coordinated profile tables are placed in vertical and horizontal, in profile tables of which each pixel line measures have been determined by taking into consideration pixel dimensions of the photograph.

5. Topographical identification and comparison system according to claim 1, wherein each unit square of section profile lines which have been placed in the coordinated profile tables or vertical and horizontal coordinate values of the pixel, section profile line pixels are recorded in the data base file in sequence.

6. Topographical identification and comparison system according to claim 1 wherein section profiles taken from the fixed reference points of the surface image are being taken as a great number of sections in the pixel ratio extent in the photograph, and measurable digital coordinate naming of certain or all pixels of these section lines are being carried out.

7. Topographical identification and comparison system according to claim 1, wherein in the stage of obtaining topographical section profiles, a profile line is being obtained on a 360-degree circle surface, in the desired level of details, at each unit degree by taking the fixed portion of the demanded surface as reference.

8. Topographical identification and comparison system according to claim 1, wherein by taking into consideration pixel dimensions of the photograph of the profile tables, in vertical and horizontal, each pixel line is determined with a measurable name (with a number data).

9. Topographical identification and comparison system according to claim 1, wherein profile lines are being placed in the profile tables.

10. Topographical identification and comparison system according to claim 1, wherein while data base archive file is being formed, each unit square of profile lines which have been placed in the profile tables or vertical and horizontal coordinate values of its pixel are being written in a sequence and the entire profile lines are being recorded in separate rows and the completed data base file is being associated with the first recorded image data.

11. Topographical identification and comparison system according to claim 1, wherein while data base information are being compared, during existence in the data base primarily numerical values corresponding to similar profile line or lines are being entered as + and − number of pixel values (deviation amount) on the horizontal and vertical axis of the profile tables of predetermined standard or acceptable deviation values to be used while comparison operation is being performed.

12. Topographical identification and comparison system according to claim 1, wherein similar (reference) profile lines which similar (reference) profile lines resulting from the calculation made are being sequenced according to similarity ratio and among the ones with the same data reference the one with the highest similarity condition is being determined as the profile line.

13. Topographical identification and comparison system according to claim 1, wherein the comparison starts firstly from the coordinate value of a profile line in the data to be compared, or if there is a predetermined zone of that line for comparison, from the first pixel of that zone.

14. Topographical identification and comparison system according to claim 1, wherein magnitude calculation is being performed with the coordinate values of each pixel, or if there is a predetermined zone for comparison, with the pixels of that zone, with the coordinate values of the entire archive data or with the profile lines of the archive data or if there is a predetermined zone for comparison with the coordinate values of the pixels of that zone.

15. Topographical identification and comparison system according to claim 1, wherein similar archive data are determined and archive data which profile lines determined by performing magnitude calculation with the similarly respective surface coordinate values are associated with are being sequenced.

16. Topographical identification and comparison system according to claim 1, wherein topographical structures such as trace and wavy structural conditions of the surface areas having fixed references such as circle, square, rectangle, regular polygon are being converted to a digital data for performing the similarity comparison with the other examples of the same kind.

17. Topographical identification and comparison system according to claim 1, wherein archive data which has been sequenced is being calculated separately within the desired similarity ratio range with all profile lines, reference profile line being used as auxiliary, of the comparison data of the remaining all profile lines.

18. Topographical identification and comparison system according to claim 1, wherein similar archive data or data with the desired sequencing is being transmitted to the operator.

19. Identification and comparison system provides the comparison of 2 or 3 dimensional photographs of all scales of the structure which are in need of surface structure comparison, modellings taken with a laser scanning tool or standard reference digital example of a structure with real examples characterized by comprising;
topographical section profiles having 2 or 3 dimensional photographs of all scales, modellings taken with a laser scanning tool or measured section view of standard reference digital example of a surface structure,
coordinated profile tables of which each pixel line has been determined with a measurable name in vertical and horizontal by taking into consideration the pixel dimensions of a 3 dimensional photograph.

20. Topographical identification and comparison system according to claim 19, comprising data base archive file in which vertical and horizontal pixel lines of the coordinated profile tables are defined by a measurable variable and each pixel is expressed with a measurable coordinate name and each row expresses a profile line.

21. Topographical identification and comparison system according to claim 19, comprising profile lines which have been placed in coordinated profile tables in which vertical and horizontal coordinate values of each unit square or pixel are written in a sequence.
